(19) United States
(12) Patent Application Publication
(10) Pub. No.: US 2026/0268096 A1
(43) Pub. Date: Sep. 10, 2026

(54) MANAGING INTERACTIONS WITH ARTIFICIAL INTELLIGENCE CHATBOTS

(71) Applicant: MicroStrategy Incorporated, Vienna, VA (US)

(72) Inventors: Darren Holmblad, Arlington, VA (US); En Li, Hangzhou, Zhejiang Province (CN); Haocan Xu, Hangzhou City, Zhejiang Province (CN); Kai Wang, Hangzhou City, Zhejiang Province (CN); Wei Jiang, Hangzhou City, Zhejiang Province (CN); Shu Liu, Hangzhou City, Zhejiang Province (CN); Xiaokun Hou, Vienna, VA (US)

(21) Appl. No.: 19/660,964

(22) Filed: Apr. 28, 2026

Related U.S. Application Data
(63) Continuation-in-part of application No. 19/192,183, filed on Apr. 28, 2025.
(60) Provisional application No. 63/796,261, filed on Apr. 28, 2025.
(60) Provisional application No. 63/640,110, filed on Apr. 29, 2024.

(51) Int. Cl. G06F 40/40; G06F 40/35; G06N 3/042; H04L 51/02

(52) U.S. Cl. CPC G06F 40/40; G06F 40/35; G06N 3/042; H04L 51/02

(57) ABSTRACT

Methods, systems, and apparatus, including computer-readable media storing executable instructions, for managing interactions with artificial intelligence chatbots. In some implementations, a system stores vector embeddings for each of multiple chatbots. The system receives a text input from a user that is entered at a user device of the user. The system selects a chatbot from among multiple chatbots based on a measure of similarity of a vector embedding for the text input from the user to a vector embedding for the selected chatbot. The system generates a chatbot response to the text input from the user using the selected chatbot and provides the chatbot response for presentation at the user device.

### CROSS-REFERENCE TO RELATED APPLICATIONS

This application claims the benefit of priority to U.S. Provisional Patent Application No. 63/796,261, filed on April 28, 2025, and this application is a continuation-in-part of U.S. Patent Application Serial No. 19/192,183, filed on April 28, 2025, which claims priority to U.S. Provisional Patent Application No. 63/640,110, filed on April 29, 2024, and the entire contents of each of the prior applications is incorporated by reference herein.

### BACKGROUND

The present specification relates to techniques for managing applications, interfaces, and modules that leverage artificial intelligence and machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system provides an agent or interface that can act as an intermediary or manager for multiple artificial intelligence or machine learning (AI/ML) applications or models. The agent or interface can provide a unified or centralized interface for a user to access any or all of a diverse set of AI/ML tools. The agent or interface can have the capability to automatically select which AI/ML tools are appropriate for a user’s task or context, so the user does not need to manually specify which of the available AI/ML tools should be used. The agent or interface can then interact with one or more of the AI/ML tools that the agent or interface selects, and provide a result to the user. The result can be an aggregation or combination of responses from different AI/ML tools, so the agent or interface provides information from multiple AI/ML tools in a response to a single user request.

For example, a user may be granted access to several AI/ML chatbots, each with different capabilities, domains, or datasets with which to provide responses. The agent or interface can be positioned between a user and various AI/ML chatbots, so that the agent or interface distributes a user’s question to multiple AI/ML chatbots. The agent or interface can evaluate and process the responses from multiple AI/ML chatbots, to provide the user with a concise, relevant result that combines useful information from multiple AI/ML chatbots.

Based on user interactions and feedback, the agent or interface can learn over time which chatbots are most appropriate for different types of user requests (e.g., for user queries in specific domains or with particular keywords). For example, the agent or interface may include an AI/ML model that is trained to select which of various AI/ML chatbots are most relevant for particular topics, contexts, user groups, keywords, and so on. The agent or interface can then selectively distribute or route user requests to the AI/ML chatbots that the agent’s model indicates as most likely to be relevant to the user’s request. A single user request to the agent can be distributed to multiple AI/ML chatbots that the agent predicts to be relevant, and the agent can filter or combine the responses from different AI/ML chatbots to provide a high-quality result that may seamlessly combine information from different AI/ML chatbots.

The agent or interface also increases efficiency by using a trained AI/ML model or other techniques to predict which subset of AI/ML chatbots are relevant for different requests or contexts. By predicting which subset of AI/ML chatbots is relevant, and by limiting the number of AI/ML chatbots that a user question is distributed to, the agent or interface limits the power consumption and computational demands for obtaining responses. The agent or interface can select a specific AI/ML chatbot, or a specific subset of AI/ML chatbots, that are most likely to provide the requested information. The selections can be informed by the examples of previous user questions and the AI/ML chatbots selected for those questions. For example, the system can obtain feedback from users about the answers the agent provides, and thus the set of chatbots the agent selected. The user feedback can be explicit (e.g., through user ratings, survey answers, quality rankings, etc.) or implicit (e.g., positive interaction such as sharing, saving, and otherwise using responses; negative interactions such as repeating or rephrasing a question when dissatisfied with a response, dismissing a response, abandoning or closing an interface, requesting a specific model or chatbot, etc.). Based on the user feedback, the agent can learn to select AI/ML chatbots or other AI/ML tools that are appropriate to a user’s request and can provide a relevant or effective response. In many cases, the appropriate AI/ML chatbot(s) to answer a user’s question will be the one that the user feedback indicates to have provided effective answers for similar questions (e.g., questions with the same topic, domain, keywords, contexts, etc.).

The API that provides access to the chatbot system can be made accessible to the public, allowing connection to 3rd party tools. The system can provide a simple way to answer data questions even though the answers can come from various different chatbot. The system can consider chatbot access control lists (ACLs) so that users can only access the chatbots they are authorized to access. Users can be enabled to configure the chatbot system within other applications they are using with an experience consistent with chatbot accessibility through main interface.

The API accessible to the public can allow a question or user prompt to be sent to a single API endpoint. Most likely the above request would be asynchronous, and there should be another endpoint that would allow the end user to query the status of the answer and get the answer content. The system can provide users the option to generate visualization as a static image or data series that can be rendered by visualization software development kit.

When the system searches for chatbots, the scope can be adjusted to use the concept of content groups at the application level. All the chat chatbots included in all the default content groups under one application can be included as RAG search targets.

In some cases, relying solely on the user-added chatbot description will not be sufficiently accurate to create the vector embeddings for accurate chatbot selection and question routing. To address this, the system can automatically generate a text summary that contains full information of the underlying datasets accessible be a chatbot. This can be a default option (e.g., on unless disabled manually) in the chatbot configuration. For example, information about the data sets, including the data objects (e.g., attributes, metrics, etc.) including their names, semantic roles or meanings, and data types can be included and used to generate the vector embeddings. Much of this information can be obtained from a data model or data schema for the data sets that a chatbot is configured to access. The system can append user-added chatbot description to this overall chatbot summary that we would create the vector embedding that will be used to match the user question to a chatbot.

The system can also be configured to obtain suggested questions from each of multiple chatbots. For example, the system can obtain a predetermined number (e.g., 5) suggested questions randomly from all chatbots the user is authorized to access. As a result, the system can provide a mix of suggested questions from different chatbots all on the same interface. A single API or request type can be used to send a question to the chatbot system, even though any of multiple chatbots may be used to answer it. In addition, the API can be configured to generate and provide a summary of all chatbots the user is authorized to access.

In one general aspect, a method performed by one or more computers includes: storing, by the one or more computers, vector embeddings for each of multiple chatbots; receiving, by the one or more computers, a text input from a user that is entered at a user device of the user; selecting, by the one or more computers, a chatbot from among multiple chatbots that the user is authorized to access based on the text input from the user, wherein the chatbot is selected based on a measure of similarity of a vector embedding for the text input from the user to a vector embedding for the selected chatbot; based on the selection, generating, by the one or more computers, a chatbot response to the text input from the user using the selected chatbot; and providing, by the one or more computers, the chatbot response for presentation at the user device.

In some implementations, the vector embedding for each chatbot of the multiple chatbots is based on properties of one or more data sets that the chatbot is configured to access.

In some implementations, the vector embedding for each chatbot of the multiple chatbots is based on a description or label for the chatbot.

In some implementations, the vector embedding for each chatbot of the multiple chatbots is based on previous user interactions with the chatbot.

In some implementations, selecting the chatbot includes: identifying a set of multiple candidate chatbots to answer the text input from the user, wherein the multiple candidate chatbots are identified based on the similarity of their corresponding vector embeddings to the vector embedding for the text input from the user; providing information describing the multiple candidate chatbots to an artificial intelligence and/or machine learning (AI/ML) model with an instruction for the AI/ML model to select a chatbot that is appropriate to generate a response to the text input from the user or to rank or re-rank the multiple candidate chatbots; and selecting a chatbot indicated by a response of the AI/ML model.

In some implementations, the AI/ML model is a large language model (LLM).

In some implementations, the method includes: detecting that a chatbot has been added or altered; and in response to detecting that the chatbot has been added or altered, generating one or more new vector embeddings to register the added or altered chatbot.

In another general aspect, a method performed by one or more computers includes: providing, by the one or more computers, an interface for creating or editing an interactive application configured to provide responses generated using one or more artificial intelligence (AI) or machine learning models; receiving, by the one or more computers, customization data through the interface, wherein the customization data indicates customizations specified by a user to customize the interactive application, wherein the customization data identifies a data set for the interactive application and specifies one or more characteristics of behavior of the interactive application; storing, by the one or more computers, one or more records specifying configuration settings representing the customizations for the interactive application; and providing, by the one or more computers, access to the interactive application with the customizations for one or more users, such that the interactive application is configured to generate a response to a user prompt using (i) a result determined from the data set based at least in part on the user prompt and (ii) content generated by the one or more AI or machine learning models from processing the result determined from the data set.

In some implementations, the interactive application comprises a chatbot, and the one or more AI or machine learning models comprises a large language model.

In some implementations, providing the interface comprises providing data for a user interface of a web page or web application.

In some implementations, providing the interface comprises providing an application programming interface.

In some implementations, providing the interface comprises providing user interface data for a user interface comprising (i) a set of interactive elements to that are selectable by a user to change settings of the interactive application, and (ii) a region for interacting with the interactive application, including an input control configured to submit user prompts and an output area configured to provide responses of the interactive application to the user prompts.

In some implementations, the interface includes one or more controls to alter an appearance of the interactive application; the customization data indicates customizations specified by the user that include changes to the appearance of the interactive application; and the stored one or more records indicate the changes to the appearance of the interactive application.

In some implementations, the interface includes one or more controls to alter one or more messages to provide to users of the interactive application; the customization data indicates customizations specified by the user that include the one or more messages; and the stored one or more records indicate the one or more messages to provide to users of the interactive application.

In some implementations, the interface includes one or more controls to set whether the interactive application can use information from the Internet to respond to user prompts; the customization data indicates customizations specified by the user that include a setting whether the interactive application can use information from the Internet to respond to user prompts; and the stored one or more records indicate the setting whether interactive application can use information from the Internet to respond to user prompts.

In some implementations, the interface includes one or more controls to control access to the interactive application by users; the customization data indicates customizations specified by the user that adjusts which users can access the interactive application; and the stored one or more records indicate criteria specifying which users can access the interactive application.

In some implementations, the interface includes one or more controls to limit an amount of usage of the interactive application by users; the customization data indicates customizations specified by the user that set a limit on the amount of usage of the interactive application by users; and the stored one or more records indicate the limit on the amount of usage of the interactive application by users.

In some implementations, the interface includes one or more controls to limit the portions of the data set that can be used to generate responses provided by the interactive application; the customization data indicates customizations specified by the user that specify a subset of the data set to be used by the interactive application to generate responses; and the stored one or more records indicate the subset of the data set to be used by the interactive application to generate responses.

In some implementations, the interactive application is configured to vary which portions of the data set are used to provide responses by the interactive application to different users based on respective permissions or access levels of the different users.

In some implementations, the one or more AI or machine learning models comprises a third-party AI or machine learning model; and the interactive application is configured to generate responses to user prompts based on (i) generating results to the user prompts from the data set using a data processing system, and (ii) providing the generated results to the third-party AI or machine learning model, so that the third-party AI or machine learning model generates content for the responses without direct access to the data set.

In some implementations, the result comprises result data generated by a database management system based on a query or set of processing operations determined using the user prompt; and the interactive application is configured to obtain the content from the one or more AI or machine learning models by requesting that the one or more AI or machine learning models summarize results from the database system.

In some implementations, the interactive application is configured to generate a response to a user prompt by performing operations including: sending a first request to the one or more AI or machine learning models based on the user prompt, wherein the first request requests instructions for analyzing the data set based on the user prompt; causing data processing instructions that the one or more AI or machine learning models generated in response to the first request to be carried out using deterministic processing of a data processing system separate from the AI or machine learning models; sending a second request to the one or more AI or machine learning models, including results generated by carrying out the data processing instructions and a request to generate text based on the results; and providing, in a response to the user prompt, text that the one or more AI or machine learning models generated in response to the second request.

In some implementations, the first request is a request for instructions specified in code of a programming language; and wherein causing the data processing instructions to be carried out comprises causing the instructions specified by the code of the programming language to be performed.

In some implementations, the interactive application is configured to respond to at least some user prompts with data for a visualization of data from the data set, wherein the interactive application is configured to request and receive data describing characteristics of the visualization from the one or more AI or machine learning models.

In some implementations, the visualization comprises a chart or graph of a type of data indicated by the one or more AI or machine learning models based on information from a user prompt, with the chart or graph depicting values for the type of data wherein the values are determined by a database system separate from the one or more AI or machine learning models.

In one general aspect, a method performed by one or more computers includes: receiving, by the one or more computers, a text input from a user that is entered at a user device of the user; identifying, by the one or more computers, multiple chatbots that the user is authorized to access, wherein at least some of the multiple chatbots are configured to answer questions about data from different data sources; selecting, by the one or more computers, a subset of the multiple chatbots based on the text input from the user, wherein the subset includes at least one of the multiple chatbots and fewer than all of the multiple chatbots; providing, by the one or more computers, the text input from the user to each of the chatbots in the subset to generate a response to the text input from each of the chatbots in the subset; and providing, by the one or more computers, an output response to the text input from the user for presentation at the user device, wherein the response is based on one or more of the responses generated the chatbots in the subset.

In some implementations, receiving the text input includes receiving the text input over a communication network at a server system; each of the multiple chatbots are configured to generate responses using one or more artificial intelligence and/or machine learning models; and providing the output response to the text input includes providing the output response from the server system over the communication network to the user device.

In some implementations, receiving the text input includes receiving the text input through an application programming interface (API).

In some implementations, the text input from the user is entered through a messaging interface or a chatbot interface, and wherein the messaging interface or a chatbot interface is configured to selectively provide access to each of the multiple chatbots without the user selecting or specifying which chatbot to interact with.

In some implementations, the one or more computers are configured to automatically select, for each of multiple user prompts, which of the multiple chatbots to use to respond to the user prompt.

In some implementations, the method includes receiving a series of user prompts in a conversation, and varying which of the multiple chatbots is used to answer the respective user prompts based on content of the respective user prompts.

In some implementations, the selected subset of the multiple chatbots includes at least two chatbots; and the output response is generated based on the responses of each of the at least two chatbots.

In some implementations, the output response combines information from the responses of the at least two chatbots.

In some implementations, the method includes generating the output response, including by using one of the responses of the at least two chatbots to verify or validate another of the responses of the at least two chatbots.

In some implementations, the method includes monitoring for subsequent interactions of the user after the output response is provided; detecting an interaction of the user after the output response is provided; and adjusting a process of selecting chatbots to respond to user input based on the detected interaction of the user.

In some implementations, the method includes storing a registry of chatbots, including storing an association of each of the chatbots with one or more topics, data sets, data objects, types of data, or keywords; and selecting the subset of the multiple chatbots includes selecting the subset of the multiple chatbots based on similarity or relevance of the topics, data sets, data objects, types of data, or keywords associated with the respective chatbots with respect to the text input from the user.

In some implementations, selecting the subset of the multiple chatbots includes using a machine learning model to select from among the multiple chatbots.

In another general aspect, a method performed by one or more computers includes: monitoring, by the one or more computers, messages in a messaging platform to detect a reference to an artificial intelligence or machine learning (AI/ML) chatbot system; based on the monitoring, detecting, by the one or more computers, a reference to the AI/ML chatbot system in a message in a conversation between two or more users; in response to detecting the reference in the message, selecting, by the one or more computers, a chatbot from among multiple chatbots to generate a response to the message that includes the reference, wherein the chatbot is selected based on content of the message; and providing, by the one or more computers, a response generated by the selected chatbot as a message in the conversation between the two or more users.

In some implementations, monitoring the messages includes monitoring for the presence of a predetermined keyword corresponding to the AI/ML chatbot system; and detecting the reference includes detecting the predetermined keyword in the message.

In some implementations, the method includes identifying a set of authorized chatbots that the users in the conversation are authorized to access; and the chatbot selected from among the identified set of authorized chatbots.

In some implementations, the conversation does not include a chatbot or agent of the AI/ML chatbot system as a participant in the conversation, such that the reference is provided before the AI/ML chatbot system participates in the conversation.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for managing interactions with artificial intelligence or machine learning (AI/ML) chatbots.

FIG. 2 is a diagram showing additional architecture information for the system for managing interactions with AI/ML chatbots.

FIG. 3 is a diagram showing techniques for ranking candidate chatbots.

FIG. 4 is a diagram showing techniques for learning and improving the selection of chatbots.

FIGS. 5A-5B are example user interfaces for interacting with chatbot.

Like reference numbers and designations in the various drawings indicate like elements.

### DETAILED DESCRIPTION

In some implementations, a system can facilitate access to chatbots and other AI/ML functionality. The system can provide a consistent, unified interface to the user across many different chatbots from different sources and for different topics or datasets. A chatbot can be an application or interactive module, connected to one or more datasets, that is able to answer questions about its corresponding dataset(s). A chatbot can combine reliable database operations (e.g., deterministic or non-stochastic processing) and information retrieval with generative AI/ML processing, using retrieval-augmented generation (RAG) or other techniques. The system can provide a single interface to a user as a way to combine or the chatbot experiences or interfaces that a user has access to in an enterprise environment. The system can then select which of multiple chatbots is most appropriate to answer a user’s question based on an index, which in some cases can be a vector database, that associates chatbots with different topics, keywords, data objects, data types, and other semantic information. In some implementations, this can be performed similar to a RAG retrieval process, but with the retrieval being the identification of the chatbot to use to answer a question, rather than simply selecting text to provide as context to an AI/ML model.

In operation, the system can largely abstract the details of many chatbots that a user may have access to, so the user does not have to select and seek out the specific chatbot interface for each chatbot one-by-one and question-by-question. The system can use vector search functionality to automatically select which of multiple chatbots should answer a user’s question, so the user does not need to manually select or specify which chatbot to interact with. As a result, the system provides a single, unified interface across many different chatbots. This allows quick access to the chatbots and allows the user to carry on a conversation that changes topics or subject matter domain from question to question, even if that would involve switching from one chatbot to another.

As discussed further below, the system can be configured to generate an index of the available chatbots and their associated data. For example, information about a chatbot, e.g., its name, metadata, relevant topics, associated datasets (and data objects in those datasets), can be represented as an embedding or vector in a high-dimensional space and stored in a vector database. When a question from a user is received, the system can generate embeddings or vectors from the user’s question, and then compare the question vectors with the stored chatbot vectors. The system can determine which chatbot has stored vectors that are closest (e.g., smallest vector distance) from the question vectors to identify the chatbot that is most relevant and capable of answering the user’s question. For example, when a user refers to a particular type of data (e.g., employee phone number, sales amount, etc.) the system can use the vector search to identify the chatbot that is best suited to retrieve and provide answers about those data objects. This can be done by indexing the chatbots at least in part based on the metrics, attributes, or other data objects that the chatbots are configured to use (e.g., the data objects specified by the data models or data schemas of the datasets the chatbot can access). The system can perform chatbot selection analysis at multiple points during a conversation, including to change which chatbot is used when appropriate. As a result, if a user changes the topic of the conversation or references a different dataset, the system can automatically detect that another chatbot would be better suited to answer the next question, and the system automatically switches to use the other chatbot to generate a response.

As an example, a user at a company may have access to three chatbots that have access to different datasets, such as a chatbot for product technical specifications, a chatbot for product sales information, and a chatbot for human resources at the company. The user can ask a first question about a product’s specifications, and based on the content of the question the system can automatically route that question to the technical specifications chatbot and then give the user the answer generated by the technical specifications chatbot. For the next question in the session, the user can ask about sales of the product discussed in the previous question. Based on the content of the second question, the system can determine that the product sales chatbot is more relevant, and then route the second question to the product sales chatbot instead. In doing so, the system can include the first question and answer as context, allowing the product sales chatbot to better interpret the second question (e.g., to correctly disambiguate references to items mentioned in the first question and answer). The system then gives the user the answer to the second question that the product sales chatbot provided, in the same user interface and conversation that also showed the first question’s answer from the technical specifications chatbot. In this manner, the user gains access to the capabilities and datasets of all of the chatbots, without the need to manually identify which chatbots to use at which times or switch between different conversations.

Because the system can manage the routing of user prompts to chatbots on behalf of the user, based on the relevance of the respective chatbots for the current user prompt and context, the user does not need to know which chatbots are available or are most appropriate for the current question. This frees the user to focus on forming appropriate questions, without the need for the user to evaluate which chatbots are available to the user and which datasets or capabilities the various chatbots possess. In some implementations, the system selects chatbots, distributes user prompts, and returns responses in a manner that abstracts away the underlying complexity. For example, the interface may not even indicate to the user the number of chatbots that are available, or which chatbots are being queried, or which chatbots provided specific answers, unless the user requests the information or requests to chat with specific chatbots.

The system can include various capabilities to reliably select chatbots that provide accurate and relevant results to user questions, from among a larger set of chatbots. As discussed further below, the system can track user interactions and derive explicit and implicit user feedback about which chatbot responses are acceptable to users and which are not. From the interactions, the system can learn or refine its index of which chatbots are most suited for specific domains, topics, keywords, datasets, tasks, user roles, users, user groups, and so on. The system can continue to learn from user interactions in an ongoing manner, and may increase the accuracy of the selection system by updating or adding the embeddings or vectors that associate chatbots with topics, keywords, and other semantic identifiers.

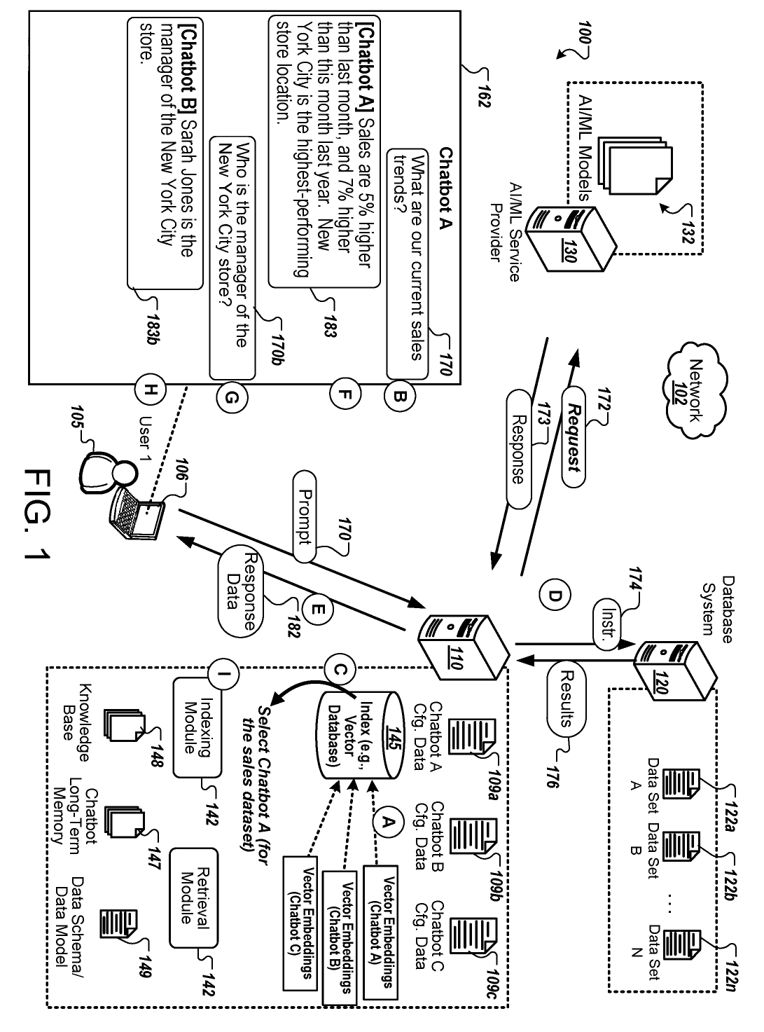

FIG. 1 is a diagram showing an example of a system 100 for managing interactions with AI/ML chatbots. The system 100 includes a computer system 110, a database system 120, and an AI/ML service provider 130. The system 100 also includes a user device 106 of a user 105. The elements of the system 100 communicate over a network 102, such as the Internet. The computer system 110 provides access to multiple chatbots, and can automatically select which of multiple chatbots is most appropriate to answer each user prompt (e.g., each user question).

The computer system 110 can provide interactions with chatbots through an application programming interface (API). For example, client devices, applications, and other servers can send requests over the network 102, and the computer system 110 processes the requests to generate responses that are provided over the network 102. Part of the processing performed by the computer system 110 includes selecting which of multiple chatbots is appropriate or relevant and so should be used to answer a prompt. To do this, the computer system 110 can create and update an index 145 of available chatbots. The computer system 110 uses the index 145 to compare the semantic meaning of a prompt with the semantic meanings associated with the respective chatbots, to determine which chatbot(s) are most relevant to the user prompt. For example, the index 145 can be implemented using a vector database, where chatbots are registered or entered by storing vector representations of information about the chatbots. For each chatbot, information such as its name, description, and metadata can be represented in vector form, as well as information about the dataset(s) that the chatbot is configured to access, including information from a data model or data schema for the dataset (e.g., data indicating names, descriptions, and data types for attributes, metrics, and other data objects). In this manner, if a user references a type of information in a user prompt, such as asking to find a customer address or store location, the computer system 110 can use the vector database to find the chatbot(s) that are configured to access and answer questions about these data objects.

In the example of FIG. 1, a user 105 has a user device 106 and accesses a user interface 162 for interacting with a chatbot, such as a web page, a web application, a native application, etc. The user interface 162 can be integrated with another application, e.g., as a tab or pane that the user can view and interact with while viewing a dashboard or performing a task. The user 105 authenticates to the computer system 110, so that the user’s identity is determined and the user’s permissions can be determined. Different permissions may grant access to different sets of chatbots or to different levels of access to datasets within the chatbots. The computer system 110 enforces access control policies to limit the user 105 to accessing chatbots that the user 105 is authorized to access, and also to limit the access of each chatbot to the data that the user 105 is authorized to access.

The computer system 110 can be implemented using one or more servers, such as one or more cloud computing systems, one or more on-premises servers, etc. For example, the computer system 110 can be an application server. The computer system 110 provides front-end functionality to interface with various client devices.

The database system 120 can provide various data retrieval and processing functions. For example, the database system 120 can be a database management system (DBMS), and can include the capability to process operations specified in structured query language (SQL), Python code, or in other forms. The database system 120 stores or has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

In the example, a series of operations and data flows are shown as stages labeled (A) through (I). The operations can be performed in the order indicated or in another order. These stages represent operations for an example as discussed below, but the same operations can be repeated or supplemented in various combinations and sub-combinations also.

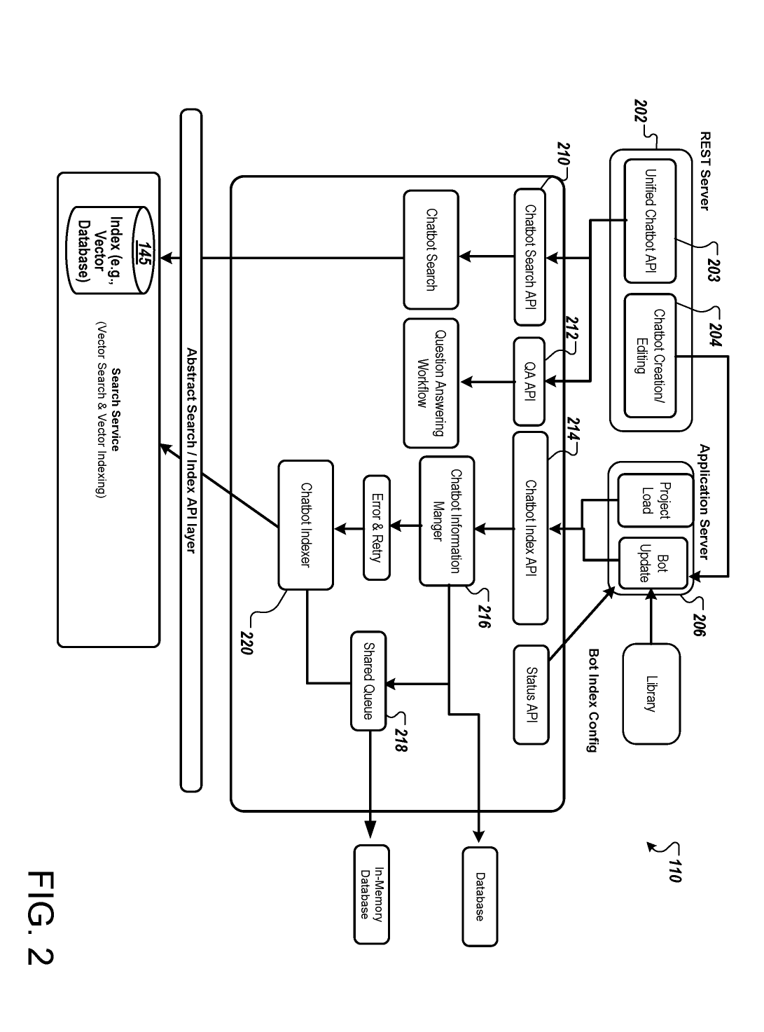

In stage (A), the computer system 110 performs indexing to create or update the index 145 of chatbots, which the computer system 110 can later use to perform a semantic search for chatbots that are most relevant to text, such as a question from a user. The computer system 110 includes indexing functionality to register chatbots and associate them with topics, data sets, keywords, and other indicators of semantic meaning. The indexing can be performed by an indexing module 142 configured for this function, and further description about architectures to facilitate indexing are described with respect to FIG. 2.

In the example of FIG. 1, the index 145 is implemented as a vector database, which enables efficient searching based on the similarity of vector embeddings in a high-dimensional space. To perform the indexing, the computer system 110 identifies each of the various chatbots that are available and collects information about the chatbots and their respective datasets. Then, for each chatbot, computer system 110 generates vector embeddings for the chatbot and enters the vector embeddings into the index 145 in association with the chatbot (e.g., a chatbot identifier). The vector embeddings for a chatbot represent semantic properties or capabilities of the chatbot, such as the types of data or the set of data objects that the chatbot has access to and can answer about. The vector embeddings can represent other aspects, such as a name of the chatbot, a description of the chatbot, tasks the chatbot performs or assists with, topics, keywords, and so on.

In further detail, in the example, there are three chatbots, Chatbot A, Chatbot B, and Chatbot C, each of which is configured to use a different dataset 122a-122n or combination of the datasets 122a-122n. Each chatbot has a corresponding set of configuration data 109a-109cwhich includes a variety of settings values that define the manner of operation, e.g., system instruction or system prompt, output formats to use, tone or style of output, the datasets 122a-122nto use, the data objects to use, and so on. Each chatbot can have associated metadata that includes, for example, a name of the chatbot, a description of the chatbot, typical tasks or uses of the chatbot, and so on.

For each chatbot, the computer system 110 retrieves the corresponding configuration data 109a-109cand/or metadata, as well as the data model or data schema for the datasets 122a-122n. The computer system 110 then extracts semantic indicators from the information. For example, the computer system 110 extracts pieces of information that are indicative of the types of data, tasks, and uses of the chatbot. This can include, for example, the name and description of the chatbot, names and descriptions of datasets 122a-122naccessed by the chatbot, names and descriptions of data objects (e.g., attributes, metrics, etc. in the datasets 122a-122n) accessed by the chatbot, topics associated with the chatbot or associated datasets 122a-122n, keywords, and so on. The computer system 110 uses these various pieces of information to generate vector embeddings, e.g., vectors in a high-dimensional space that represent the concepts or semantic meaning of the data. There can be multiple vector embeddings generated for each chatbot, based on the different pieces of information describing the chatbot and its corresponding datasets 122a-122n. The computer system 110 then enters the vectors for each chatbot into the index 145 (e.g., a vector database) in association with a chatbot identifier for the corresponding chatbot.

In general, when a server such as the computer system 110 is started, the server checks the indexing status of chatbots, and chatbots have not yet been indexed can be processed to add them to the index. Similarly, chatbots that have changed (e.g., configuration parameters or underlying dataset structure has changed) are reindexed so that the index is up to date. Typically a chatbot is reindexed when the chatbot is created, updated, or deleted.

In stage (B), the user 105 enters a user prompt 170 (e.g., a question or instruction) in the chatbot interface 162 on the user device 106. In the example, the user prompt 170 is the question, “What are our current sales trends?” The user device 106 sends the user prompt 170 to the computer system 110 over the network 102 for processing.

The chatbot interface 162 can be a unified interface that allows the user to access each of multiple different chatbots through a single user interface within a single conversation. In some implementations, the chatbot interface 162 enables the user 105 to submit a user prompt 170 without the need for the user 105 to manually select which chatbot to involve and without the need to open a conversation with a specific chatbot. The computer system 110 will be able to automatically select, from multiple chatbots, an appropriate chatbot to use to answer the user prompt 170, e.g., a chatbot that has access to the dataset(s) 122a-122nand/or data objects (e.g., attributes, metrics, etc.) with the data types needed to generate an answer to the user’s question.

The computer system 110 can provide an API that facilitates access to the collection of chatbots available to a user 105. For example, using the API, the user device 106 can send the user prompt 170 for processing, and can rely on the computer system 110 to appropriately route the user prompt 170 to the correct chatbot and provide an appropriate response. The API also provides the ability to integrate access to the full set of chatbots that is available from the computer system 110, as a collection or as an ensemble, into various third-party applications, web pages, and other software.

Using the API to access a set of chatbots offloads many tasks from the client side and increases efficiency. This can greatly simplify the work of the user device 106 and the user 105 in making a request, because there is no need to enumerate the available chatbots on the client side or to select a particular chatbot and route it to a specific chatbot. The computer system 110 also enforces access control rules, both for at the chatbot level and at the level of datasets 122a-122nand even specific data objects within datasets, so the user device 106 does not need to. Resource use can also be more efficient, by answering questions correctly with fewer rounds of interaction (and thus lower processing by AI/ML models). Because the computer system 110 can reliably select an appropriate and relevant chatbot capable to answer the question of the user 105, this increases the likelihood that the answer will be provided in one interaction, rather than requiring multiple questions and generated answers, potentially as the user asks different chatbots to find one that provides the correct answer.

In addition, the API can improve the user experience because the user 105 does not need to open separate conversation panes or initiate a switch between chatbots to access data from different chatbots. The technique also improves the accuracy of responses compared to separate conversations, because the context of the conversation is preserved even when switching chatbots. For example, after a chatbot is selected to answer a particular user prompt, the context of previous user prompts and responses in the conversation can be provided as context (e.g., for processing in the context window of the LLM). In this manner, even when the topic of a conversation changes, and the computer system 110 initiates a switch from one chatbot to another, the new chatbot benefits from the results and analysis of the other chatbot(s) through the context of the conversation.

In stage (C), the computer system 110 uses the index 145 to select a chatbot to use to answer the user prompt 170. The user prompt 170 and the request made through the API to have the user prompt 170 processed did not specify which chatbot should generate the response. The computer system 110 automatically selects which of multiple chatbots to use, based on the semantic meaning of the user prompt 170 and potentially other factors. The search or retrieval process can be performed by a retrieval module 142 of the computer system 110. In other cases, the search or retrieval can be performed by another server or system, such as a cloud computing system or a third-party search provider. In some implementations, the computer system 110 performs processing to select one chatbot that the computer system 110 predicts or determines to be most relevant to the user prompt 170. In some implementations, the computer system 110 selects multiple chatbots to use to answer the user prompt 170, although the multiple chatbots may still be subset including fewer than all of the chatbots available to the user 105.

As an example, after receiving the user prompt 170, the computer system 110 generates one or more vector embeddings based on the user prompt 170. These vector embeddings can be query vectors that are mathematical representations of the concepts or semantic meaning of portions (e.g., chunks) of the user prompt 170 or the entirety of the user prompt 170. The computer system 110 performs comparison operations to compare the query vectors, representing the meaning of the user prompt 170, with the stored vectors in the index 145. With these comparisons, the computer system 110 identifies the stored vectors that are closest to the query vectors in the high-dimensional space. Typically, the lower the distance between a query vector and a stored vector, the higher the semantic similarity of the two items represented by the vectors. As a result, the chatbot having stored vectors that are closest to the query vectors can be selected as the chatbot that is most relevant to the user prompt 170.

This can be particularly helpful when the query vector represents, at least in part, a type of data that is requested (e.g., “sales” information in the user prompt), and at least some of the stored vectors for chatbots represent the types of data that the chatbots can access from their associated datasets 122a-122n. In this case, a small distance or high similarity between a query vector and a stored vector indicates a high likelihood that the chatbot corresponding to the stored vector will have access to and be able to answer about the type of data referenced in the user prompt 170.

In some implementations, the search focuses on finding the closest stored vector to the query vector(s). In other implementations, the computer system 110 can perform various calculations to generate scores that combine or aggregate measures of distance between multiple stored vectors for a chatbot and the query vector(s). The scores can then be compared (e.g., ranked or sorted) to determine which chatbot is most semantically similar to or most relevant to the user prompt 170.

The computer system 110 can use the retrieval capabilities of the index 145 to select a single, best-matched chatbot for the user prompt 170. As noted above, the selected chatbot can be the chatbot that the vector search process indicates is semantically closest to the concepts, keywords, and/or phrases in the user prompt 170. In some implementations, the computer system 110 makes the chatbot selection directly based on the results or scores obtained using the index 145. In other implementations, the computer system 110 can use one or more AI/ML models to process the results obtained using the index 145. For example, the computer system 110 can identify highest-ranking or highest-relevance subset of chatbots, e.g., a predetermined amount of chatbots (e.g., top 10, top 5, top 10%, etc.) that demonstrate the smallest distance (e.g., highest similarity) with respect to the query vectors in the vector space. The computer system 110 can then send data identifying the subset of chatbots to the AI/ML service provider 130, with a request to use one or more AI/ML models 132 to process the results. For example, the request can be for the AI/ML model 132 to re-rank the subset of chatbots indicated, based on information about those chatbots (e.g., metadata, description, usage data, user feedback, etc.) and their datasets 122a-122n(e.g., data model, data schema, description of data types or data objects included, etc.).

As a result, in a multi-step selection process, the semantic search (e.g., vector search) using the index 145 can provide an initial selection of candidate chatbots, and an AI/ML model 132 (e.g., a LLM) can refine the ranking of those candidate chatbots. The re-ranking process performed by the AI/ML model 132 to take into account not only the candidate chatbots and their associated datasets 122a-122n, but potentially also the context (e.g., history) of the conversation in which the user prompt 170 occurs, which can result in more accurate ranking of chatbot relevance than vector similarity for the user prompt 170 alone. In addition, even though the vector search uses information about a chatbot’s semantic characteristics, the total semantic information about a chatbot may be split across multiple vectors in the index 145. Re-ranking using an AI/ML model 132 allows the information about a chatbot and its associated dataset(s) 122a-122nto be considered together as a whole, which can produce a more accurate result. The computer system 110 can use results of the re-ranking to select a specific chatbot to use to answer the user prompt 170, e.g., by selecting the highest-ranked chatbot. In some implementations, the computer system 110 may select multiple chatbots (e.g., the top two highest-ranked chatbots).

In stage (D), the computer system 110 proceeds to generate a response to the user prompt 170 using the selected chatbot. In the example, the computer system 110 has selected Chatbot A based on the retrieval process using the index 145 (and potentially also interactions with the AI/ML models 132 to perform ranking or selection from among candidate chatbots). Consequently, the computer system 110 applies the configuration data 109a for the selected chatbot in generating requests to the AI/ML service provider 130, for retrieving data from the database system 120, and ultimately for providing the response to the user prompt 170.

The computer system 110 can perform a variety of interactions to generate a response to the user prompt 170. For example, the computer system 110 can send one or more requests 172 to the AI/ML service provider 130, and may receive one or more responses 173 with content generated by the AI/ML models 132. The computer system 110 can send one or more sets of instructions 174 to the database system 120 to retrieve data relevant to the user prompt 170, and the computer system 110 can receive results 176 (e.g., retrieved data, aggregated data, calculation results, etc.) from the data sets 122a-122n.

For example, the computer system 110 can send a first request to the AI/ML service provider 130, requesting for an AI/ML model 132 to generate code or instructions (e.g., a SQL statement, Python code, etc.) for retrieving data needed to answer the prompt 170. To facilitate this, the first request can include information about a particular dataset 122a that the chatbot can access. That information can be a data schema or data model 149 for the dataset 122a, so that the AI/ML model’s output can reference specific data objects actually in the dataset 122a precisely and accurately (e.g., using known identifiers for specific tables, columns, attributes, metrics, etc. that are also recognized by the database system 120). The first request can include other information, such as some or all of the data from a knowledge base 148, having preferences, definitions, and other information for an organization. The first request can include information from a chatbot long-term memory 147 that persists across conversations or user sessions, such as items learned about the user’s 105 particular preferences, criteria, etc. The response to the first request can be code or instructions generated by the AI/ML model 132 that request the values needed to answer the user prompt 170. The computer system 110 can send the generated code or instructions to the database system 120 to retrieve the values needed. Then, with the results 176 from the database system 120, the computer system 110 can send a second request to the AI/ML model 132 that includes the results 176, requesting that the AI/ML model generate a response to the user prompt 170. In response to the second request, the AI/ML model 132 can generate a response that makes use of the result 176 and so can provide accurate information to answer the user prompt 170.

In stage (E), the computer system 110 sends response data 182 with the generated response to the user prompt 170 to the user device 106 over the network. The computer system 110 can send the response data 182 with a format and messaging protocol as specified in the API for accessing chatbots.

In stage (F), the user device 106 displays the response 183 to the user prompt 170. In the example, the generated response 183 to the question “What are our current sales trends” is “Sales are 5% higher than last month, and 7% higher than this month last year. New York City is the highest-performing store location.” This response was determined using Chatbot A, which was selected from multiple chatbots in stage (C).

In the example, Chatbot A was configured to access the dataset 122a that describes sales data and so was the most capable to answer the user prompt 170. For purposes of illustration, the response 183 indicates that Chatbot A was used to generate the response, but this is not required. In many cases, the user interface 162 may provide responses from a chatbot, or provide responses from different chatbots at different times, without indicating which specific chatbot generated the response or that the chatbot used has changed.

In stage (G), the user 105 enters a second prompt 170b, “Who is the manager of the New York City store?” This question refers to employee information, not sales information. Chatbot A is not configured to access the employee dataset and so is not capable of providing the answer to this question. However, another chatbot, Chatbot B, is configured to access the employee information dataset, and so is capable of identifying the person that holds a particular role at a particular location.

When the second prompt 170b is sent to the computer system 110, the computer system 110 performs the actions described for stage (C) to search for the chatbot that would be most relevant to (e.g., have the highest semantic similarity with) the second prompt 170b. This results in the computer system 110 selecting Chatbot B as most appropriate to answer the second prompt 170b. The computer system 110 uses Chatbot B and its dataset to generate a response 183b to the second prompt 170b, using techniques described in stage (D).

In stage (H), the user device 106 shows the response 183b to the user prompt 170b on the user interface 162. The response is that “Sarah Jones is the manager of the New York City store.” Chatbot B was able to answer the question accurately based on its dataset, even though Chatbot A would not have been able to answer the question. Because the computer system 110 can automatically and dynamically route each user prompt to the appropriate chatbot, the chatbot conversation can seamlessly span many different topics or dataset. As noted above, the illustration shows an indicator that the response 183b was generated by Chatbot B, but this is not required.

In stage (I), the computer system 110 performs learning over time to improve the accuracy of identifying relevant chatbots for queries. As users interact with chatbots, they provide explicit an implicit feedback about the quality and usefulness of the results. Explicit feedback can include actions such as interacting with a thumbs-up button to indicate approval of a response or thumbs-down button to indicate negative feedback for a response, or a user text that praises a response or indicates that a response was incorrect. Implicit feedback can include user questions that accept or build on a response (indicating that the response was accurate and useful), or user questions that repeat a question or a user abandoning a conversation (indicating that a response was insufficient or unhelpful). The computer system 110 can use the user feedback to detect when the selection of a chatbot was effective or ineffective, and then incrementally adjust the selection process toward more accurate selections and away from inaccurate selections.

One way that the computer system 110 improves and enhances the selection of chatbots is by adding additional vector embeddings to the index 145 to represent concepts and contexts that represent the situations in which users indicate positive feedback (implicit or explicit) for the selection of a chatbot. For example, when a particular chatbot is selected in connection with a particular topic, dataset, keyword, etc., and user feedback is positive, the computer system can add vector embeddings for the chatbot for those topics, datasets, keywords, etc. This can serve to reinforce or expand the range of semantic contexts in which the chatbot will be selected. Similarly, the computer system 110 can remove or decrease the influence of vectors in the index 145 that result in chatbot selections that yield negative user feedback. For example, if a chatbot is selected based on similarity of a query vector to a particular stored vector for a chatbot, and the resulting use of the chatbot yields a response that receives negative feedback, the computer system 110 can remove the vector from the index 145 or assign a value that demotes, penalizes, or otherwise lowers the influence of the vector in making later selections. In many cases, the changes to the index 145 can be incremental or subject to criteria to ensure that learning of the selection process improves accuracy. For example, the addition or removal of a vector (or the increase or decrease in a vector’s influence) can be performed only subject to a condition, such as requiring a minimum confidence level, or a minimum level of repeatability or frequency (e.g., at least 3, 5, 10, instances of feedback confirming the change), before a change is made.

Another way the computer system 110 improves and enhances the selection of chatbots is by providing user feedback information to the AI/ML model 132 used for ranking or selecting from candidate chatbots. If an AI/ML model 132 is used to rank or re-rank a set of candidate chatbots, information about user feedback, such as statistics that each chatbot selection was deemed successful or not, can inform the ranking of the AI/ML model and adjust the output. Similarly, the computer system 110 can provide, with its request for chatbot ranking or selection, indications of the contexts or topics for which specific chatbots were most likely to receive positive or negative user feedback. Providing this additional information can enable the AI/ML model 132 to better make chatbot selections that will yield positive user feedback and avoid chatbot selections that tend to yield negative user feedback.

The computer system 110 can use various other techniques, including the techniques discussed in U.S. Patent Application Serial No. 19/192,183, filed on April 28, 2025, which is incorporated by reference herein.

FIG. 2 is a diagram showing additional architecture information for the system 100 for managing interactions with AI/ML chatbots. The example shows in greater detail an example of components that can be used to provide the API and chatbot selection functionality of the computer system 110 discussed in FIG. 1. The example shows that the computer system 110 can be implemented, in some cases, as multiple servers or modules.

For example, a representational state transfer (REST) server 202 provides access to a unified chatbot API 203, which is the API used to receive requests from user devices over the network 102 and process them as discussed in FIG. 1. The REST server 202 also provides chatbot creation and editing functionality 204, so administrators or other users can create and edit chatbots. An application server 206 provides the features to implement updates to chatbots and to load and run chatbots, including with information from a document library and other functionality.

The REST server 202 and the application server 206 communicate with other modules, which can be run on the same or different servers. For example, additional APIs can be provide to facilitate backend processing, including for selecting chatbots, answering user prompts, and updating the index used to select chatbots. For example, the chatbot search API 210 provides a way for incoming user prompts (e.g., requests made using the unified chatbot API 203) request to trigger the chatbot selection process. The incoming user prompt also triggers a question answering workflow, through the question answering (“QA”) API 212.

A chatbot index API 214 is provided, so that changes to chatbots or the addition or deletion of a chatbot can trigger indexing, so that the index 145 remains up to date. For example, when an administrator takes advantage of the chatbot creation and editing functionality 204, the changes are made by the application server 206, which, upon saving the change to the chatbot, sends a message indicating which chatbot has changed (e.g., including the chatbot identifier and a status indicator denoting a change) to the chatbot index API 214. This causes a chatbot information manager 216 to retrieve the information needed about the chatbot and its associated dataset(s), and to then enter the various pieces of information into a shared indexing queue 218 as elements to be indexed. A chatbot indexer 220 then processes messages from the queue 218 to, for example, update the set of vectors in the index 145. The computer system 110 includes a search service 230 that performs the indexing and search operations.

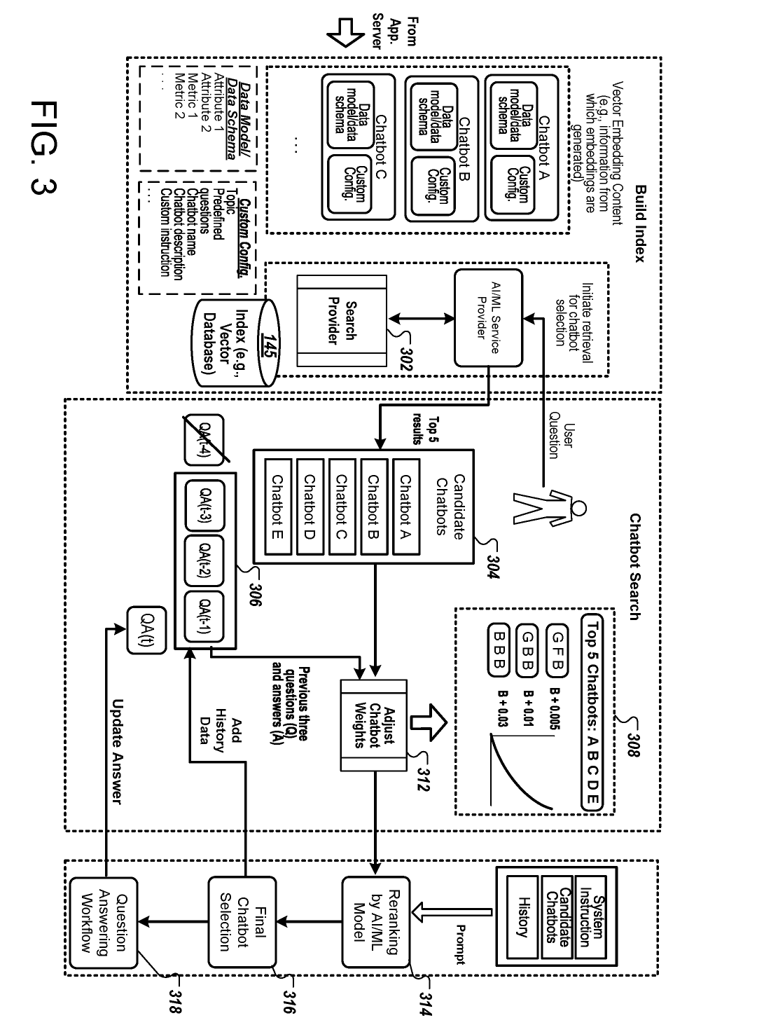

FIG. 3 is a diagram showing techniques for ranking candidate chatbots. The example shows further examples of processing by the computer system 110 for generating a search index of chatbots and also selecting chatbots, including by using an AI/ML model 132 to rank or re-rank a set of candidate chatbots determined using semantic search.

In the example, there are several chatbots (e.g., Chatbot A, Chatbot B, Chtabot C), each of which has its own custom configuration data and a data mode or data schema for the data the chatbot can access. Each data model or data schema indicates the data objects (e.g., attributes and metrics) that are available to the chatbot, and the custom configuration data indicates elements such as topics, user-defined questions (e.g., predetermined sample questions or suggested questions), a chatbot name, a chatbot description, a custom instruction to the AI/ML model, and so on. For each chatbot, the computer system 110 indexes the data from the data schema and the custom instruction to form embeddings in the index 145.

When a user asks a question, a search provider 302 uses the index 145 to identify a set of candidate chatbots 304, e.g., the top 5 chatbots that are most relevant or most semantically similar according to vector distance in the example. The computer system 110 stores historical information 306 about previous chatbot selections within the conversation as well as user feedback resulting from those selections. The computer system 110 also stores additional history data 308 representing chatbot selections made in the current conversation, or in some implementations, in previous conversations or sessions.

The computer system 110 uses the history data 308 to set or adjust weights 312 for the candidate chatbots. The computer system 110 can use information about previous selections to bias selection or improve accuracy. One technique is to apply a bias toward consistently using the same chatbot when appropriate. As a result, the weights or scores for chatbots can be increased when the chatbots are used repeatedly. In the example, the chatbot B was used in several previous conversations or sessions, and this is used to increase the likelihood that this chatbot is chosen again. An example of history data 308 shows (1) a first series of questions where chatbots G, F, and B were used, respectively, to answer three successive questions, (2) a second series of questions in which chatbots G, B, and B were used to answer three other questions, and (3) a third series of questions in which chatbot B was used in each of three successive questions. The repeated use of chatbot B in the historical data results in a boost to chatbot B, which occurs in the set of candidate chatbots 304. The inclusion of chatbot B in both the history data 308 and the set of candidate chatbots 304 results in a boost to the weight of chatbot B, with the amount of weight increasing the more the chatbot is used consecutively. For example, a geometric curve can be used for the weighting where a single selection of a chatbot (e.g., to answer one question) results in a boost to the weight by 0.005, two consecutive uses of the chatbot boosts the weight by 0.01 (e.g., 2 * 0.005), and three consecutive uses of the chatbot boosts the weight by 0. 0 (e.g., 6 * 0.005). The weight boosts can be combined, e.g., summed, to produce a final weight for the candidate chatbot B.

The computer system 110 then uses the AI/ML model 132 to re-rank (314) the candidate chatbots 304 for their relevance with respect to the user prompt. The computer system 110 can provide to the AI/ML model 132, in addition to the user prompt to be answered, information that identifies the candidate chatbots 304 and also a description of the candidate chatbots 304 (e.g., the data model or data schema and custom configuration data). The weights for the candidate chatbots, determined based on history data 306, can also be provided. In addition, the computer system 110 can provide the AI/ML model 132 information about the historical selection of chatbots, and the system information to allow the AI/ML model 132 (e.g., an LLM) to rank the chatbots). The history information can include recent history of the conversation (e.g., questions and answers for the most recent n interactions, where n is an integer such as 3), as shown in the historical information 308, or can include more detailed history about other sequences of interactions (e.g., history data 306), whether for the current conversation or for previous conversations.

After the re-ranking is completed, the highest-ranking chatbot is selected (316) to use for answering the current user prompt. The question answering workflow (318) for the computer system 110 proceeds with the selected chatbot. The computer system 110 also updates the history data 306, for example, storing the answer for the current user prompt (e.g., question and answer for time t) along with other questions and answers in the sequence (e.g., for times t-1, t-2, t-3, etc.). In some implementations, a predetermined amount of history information is used as context, such as the previous three questions and answers, for the purpose of boosting or biasing chatbot selection (adjusting chatbot weights 312) or for providing history information to the AI/ML model 132 for re-ranking 314. For example, in some cases, only the most recent three question and answer pairs (e.g., user prompt and chatbot response pairs) are provided, since these are the most relevant for the AI/ML model 132 to use in making a chatbot selection.

In some implementations, the computer system 110 caches chatbot search results and provides and API to retrieve elements of search history (e.g., vector embeddings or their corresponding text, chatbot selections, chatbot search results, etc.) to be retrieved. This information can be used by the chatbot search module to improve accuracy, and also can be used by REST APIs to suggest questions based on user’s past questions. In general, the computer system 110 can cache the chatbot search results for each application per user session. Up to three chatbot search results for each application per user session are cached and the results will expire if not updated within a threshold amount of time, such as 5 minutes.

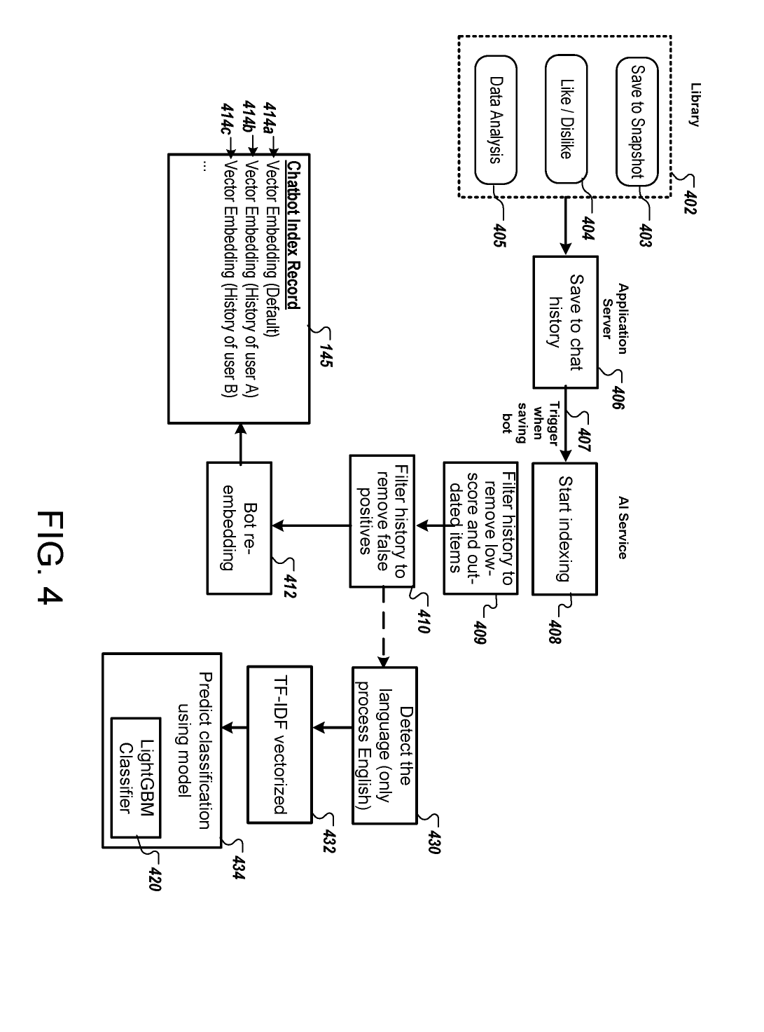

FIG. 4 is a diagram showing techniques for learning and improving the selection of chatbots. In order to improve chatbot selection accuracy, the computer system 110 can use a feedback system. The computer system 110 can take the chat history information of users as the primary feedback material to improve the accuracy of matching chatbots to user prompts. When a question appears in a chatbot's chat history and receives positive user feedback, this is a good indication that the same chatbot should be recommended to answer the same or similar question in the future. The feedback system implements learning of this type by (1) collecting user prompts, or even user prompt and response (e.g., question-answer pairs), (2) filtering the collected examples to those for which there is high confidence that user feedback was positive (e.g., removing false positives and examples with negative feedback), and (3) adding, for each high-confidence example, a vector embedding to the index 145 that associates (i) the chatbot that yielded positive feedback with (ii) a vector of the user prompt (or the user prompt and response) that resulted in the positive feedback. Adding vector embeddings in this way records an affinity between a chatbot and the previous question that the chatbot answered successfully, which will make it more likely that the same chatbot is selected to answer that question or a similar question later on.

The example shows a few example sources of information 402 that can be used to adjust chatbot selection. These include user feedback, such as a user saving a chatbot response as a snapshot 403 (a positive feedback indication), or a user selecting a like button or dislike button 404 to provide feedback. Additional data analysis 405 can also be performed to infer user feedback, including from the sequence of text prompts that a user submits to a chatbot. For example, a sequence in which a user proceeds through multiple question and answer cycles may indicate good fit for the chatbot selection for the user and the user’s question. On the other hand, a sequence in which a user repeats or rephrases the same question or ends the session abruptly may indicate a poor-quality match of the chatbot to the user or question. Keyword analysis, sentiment analysis, and other techniques can be used to analyze the language in user prompts and the pattern or trend in which a sequence of prompts develops. The information 402 is saved 406 to the chat history for processing.

When a chatbot is saved, an AI management service is triggered 407 to start the indexing process 408 based on historical interactions (e.g., previous user prompts and chatbot responses). The computer system 110 filters out historical examples that have low scores (e.g., negative user feedback) and examples that are old or outdated (409). The system also filters out false positives (410), where the results may not be successful. In some cases, a classifier 420 or other model is used to predict whether an answer is valid or useful, to avoid training for answers that are generic or unhelpful. One example of a classifier is a light gradient-boosting machine (LightGBM), although other types of classifiers can also be used. To filter an item, the computer system 110 can detect the language and verify that the language is supported 430. The data for the chat history item can then be vectorized 432 using term frequency-inverse document frequency (TF-IDF) or other statistics, to give increased weight to terms that are less common among the total set of chat interactions. The resulting vector is then processed 434 using the classifier 420 to generate a classification, which indicates whether an item should be removed as a false positive or whether the item is predicted to be a genuine positive interaction of the user with the corresponding chatbot.

Once a set of high-confidence, positively-received examples of prior user interactions with chatbots have been identified, the computer system 110 generates additional vector embeddings 412 to place in the index 145. For example, in addition to a default set of embeddings 414a based on a chatbot’s metadata and dataset, additional vector embeddings 414b, 414c have been added based on the history of positive interactions of user A and of user B. These additional vector embeddings 414b, 414ccapture information about the questions or user prompts in which the particular chatbot has answered successfully, so that the same chatbot is more likely to be selected to answer that type of question in the future. The additional vector embeddings 414b, 414cthus provide additional entries in the vector database 145 that provide opportunities to match to future situations. The addition of vector embeddings over time as shown in the example of FIG. 4A enables the computer system 110 to improve its own accuracy and reliability over time, through automated analysis and feedback, as users interact with the chatbots selected by the computer system 110.

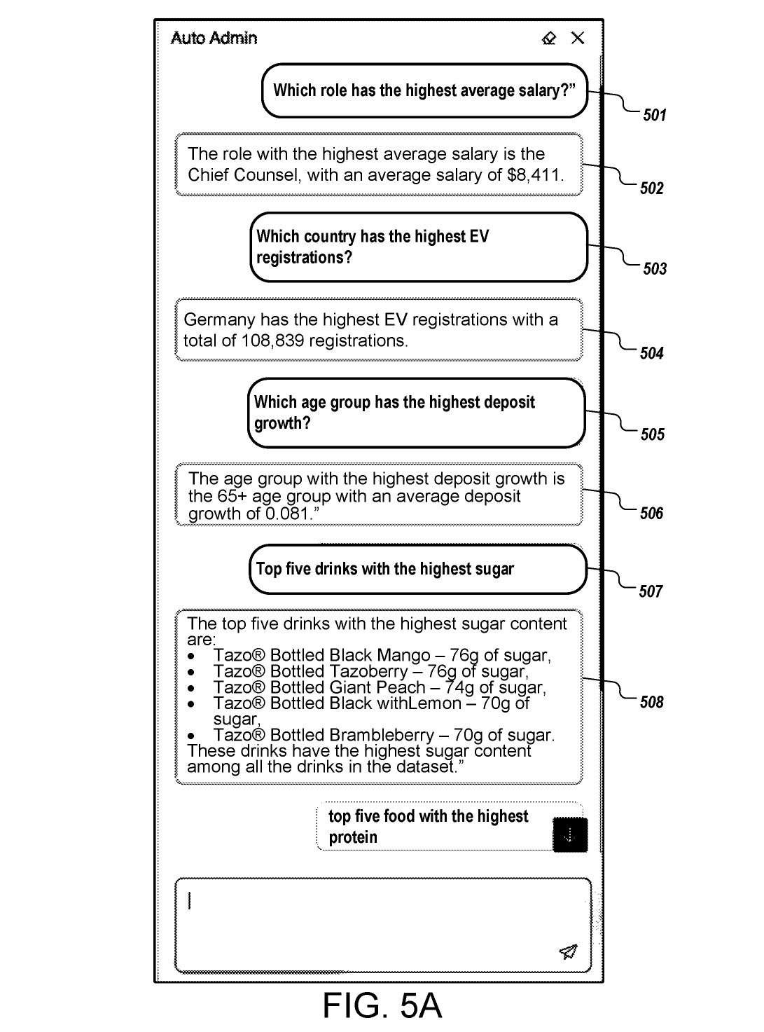

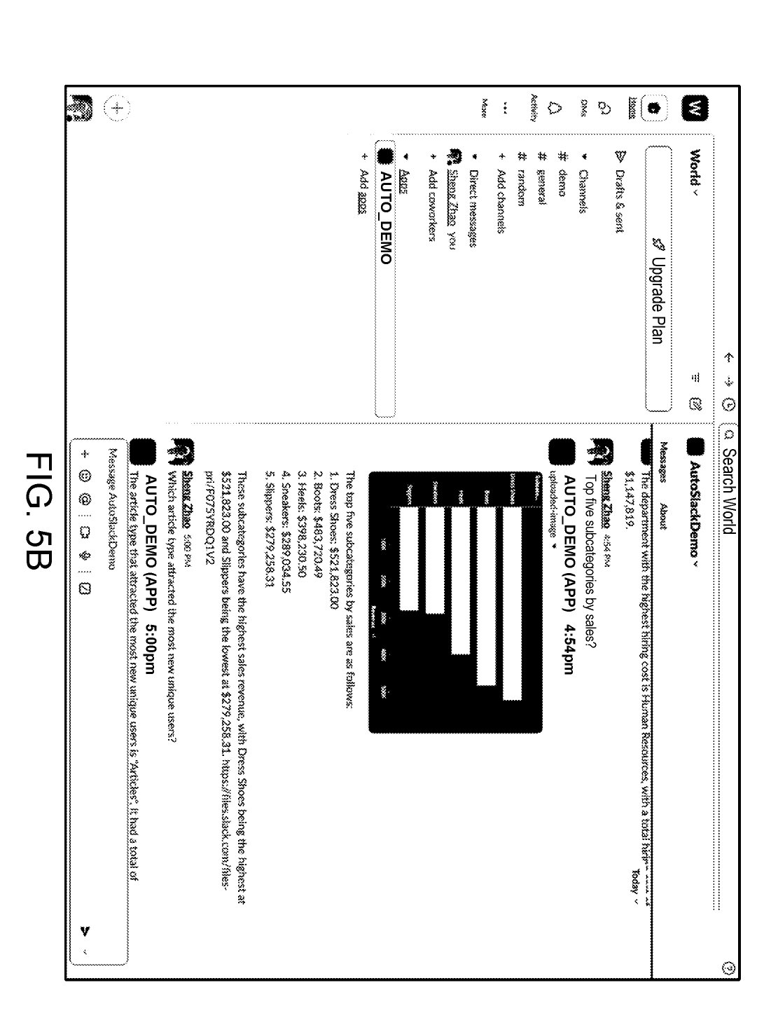

FIGS. 5A-5B are example user interfaces for interacting with chatbot. In the examples, different questions can be answered using different chatbots. Each user prompt is analyzed separately, so that an appropriate chatbot is selected and used to answer the prompt, even if the user interface does not indicate the change in chatbot.

For example, the first question 501 “Which role has the highest average salary?” is a question that should be answered from an employee database, from a human resources chatbot. That is what the system 110 selects, based on a nearest-neighbor or similarity search based on the vector embedding of the question 501 and stored vector embeddings for the human resources chatbot. The result is the accurate response 502, “The role with the highest average salary is the Chief Counsel, with an average salary of $8,411.”

The next question 503 from the user, in the same session and conversation, is “Which country has the highest EV registrations?” This question changes the topic of conversation and needs a different data set and a different chatbot to answer. The system 110 automatically selects the appropriate chatbot to answer, this time a vehicle data chatbot and data set. By interacting with this chatbot, the system 110 obtains an appropriate response 504, “Germany has the highest EV registrations with a total of 108,839 registrations.”

The next question 505 from the user, in the same session and conversation, is “Which age group has the highest deposit growth.” This question again changes the topic and needs information about banking deposit information. Based on a vector search (e.g., similarity, nearest-neighbor, minimum distance, etc.), the system 110 selects a banking chatbot to handle the question, one that is configured to access the needed data set. As a result, the banking chatbot provides an accurate answer, “The age group with the highest deposit growth is the 65+ age group with an average deposit growth of 0.081.”

The next question 507 from the user, in the same session and conversation, is “top five drinks with highest sugar.” This question 507 requests information about food product nutrition, and the system 110 finds that yet another chatbot would be the best fit based on the vector embedding similarity between an embedding for the question 507 and stored embeddings for the chatbots. The system 110 selects a nutrition information chatbot and provides a response 508, “The top five drinks with the highest sugar content are: Tazo® bottled Black Mango – 76g of sugar, Tazo® bottled Tazoberry – 76g of sugar, Tazo® bottled Giant Peach – 74g of sugar, Tazo® bottled Black with Lemon – 70g of sugar, Tazo® bottled Brambleberry – 70g of sugar. These drinks have the highest sugar content among all the drinks in the dataset.”

As discussed above, the vector embeddings used to select chatbots can be determined based on a number of factors, including the data set and data objects for the chatbot (e.g., content of a data model for the data sets used by the chatbot), based on previous user history and user feedback, and more.

FIG. 5B shows an example where the chatbot system is communicating with a user in a messaging interface. The chatbot, called “AUTO_DEMO” is shown as a participant in the conversation. As one or more users ask questions or give instructions, the chatbot system responds with a generated answer from one of the multiple chatbots in the system 110, as determined by the system 110 based on the vector similarity of vector embeddings generated from user messages and the stored vector embeddings for the chatbots that the user(s) are authorized to communicate with. The selection and use of chatbots is seamless to the users in the interface.

The computer system 110 can use various other techniques to select chatbots and route questions to chatbots, including the techniques discussed in U.S. Patent Application Serial No. 19/192,183, filed on April 28, 2025.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method performed by one or more computers, the method comprising:
storing, by the one or more computers, vector embeddings for each of multiple chatbots;
receiving, by the one or more computers, a text input from a user that is entered at a user device of the user;
selecting, by the one or more computers, a chatbot from among multiple chatbots that the user is authorized to access based on the text input from the user, wherein the chatbot is selected based on a measure of similarity of a vector embedding for the text input from the user to a vector embedding for the selected chatbot;
based on the selection, generating, by the one or more computers, a chatbot response to the text input from the user using the selected chatbot; and
providing, by the one or more computers, the chatbot response for presentation at the user device.

2. The method of claim 1, wherein the vector embedding for each chatbot of the multiple chatbots is based on properties of one or more data sets that the chatbot is configured to access.

3. The method of claim 1, wherein the vector embedding for each chatbot of the multiple chatbots is based on a description or label for the chatbot.

4. The method of claim 1, wherein the vector embedding for each chatbot of the multiple chatbots is based on previous user interactions with the chatbot.

5. The method of claim 1, wherein selecting the chatbot comprises:
identifying a set of multiple candidate chatbots to answer the text input from the user, wherein the multiple candidate chatbots are identified based on the similarity of their corresponding vector embeddings to the vector embedding for the text input from the user;
providing information describing the multiple candidate chatbots to an artificial intelligence and/or machine learning (AI/ML) model with an instruction for the AI/ML model to select a chatbot that is appropriate to generate a response to the text input from the user or to rank or re-rank the multiple candidate chatbots; and
selecting a chatbot indicated by a response of the AI/ML model.

6. The method of claim 5, wherein the AI/ML model is a large language model (LLM).

7. The method of claim 1, comprising:
detecting that a chatbot has been added or altered; and
in response to detecting that the chatbot has been added or altered, generating one or more new vector embeddings to register the added or altered chatbot.

8. A system comprising:
one or more computers; and
one or more computer-readable media storing instructions that are operable, when executed by the one or more computers, to perform operations comprising:
storing, by the one or more computers, vector embeddings for each of multiple chatbots;
receiving, by the one or more computers, a text input from a user that is entered at a user device of the user;
selecting, by the one or more computers, a chatbot from among multiple chatbots that the user is authorized to access based on the text input from the user, wherein the chatbot is selected based on a measure of similarity of a vector embedding for the text input from the user to a vector embedding for the selected chatbot;
based on the selection, generating, by the one or more computers, a chatbot response to the text input from the user using the selected chatbot; and
providing, by the one or more computers, the chatbot response for presentation at the user device.

9. The system of claim 8, wherein the vector embedding for each chatbot of the multiple chatbots is based on properties of one or more data sets that the chatbot is configured to access.

10. The system of claim 8, wherein the vector embedding for each chatbot of the multiple chatbots is based on a description or label for the chatbot.

11. The system of claim 8, wherein the vector embedding for each chatbot of the multiple chatbots is based on previous user interactions with the chatbot.

12. The system of claim 8, wherein selecting the chatbot comprises:
identifying a set of multiple candidate chatbots to answer the text input from the user, wherein the multiple candidate chatbots are identified based on the similarity of their corresponding vector embeddings to the vector embedding for the text input from the user;
providing information describing the multiple candidate chatbots to an artificial intelligence and/or machine learning (AI/ML) model with an instruction for the AI/ML model to select a chatbot that is appropriate to generate a response to the text input from the user or to rank or re-rank the multiple candidate chatbots; and
selecting a chatbot indicated by a response of the AI/ML model.

13. The system of claim 12, wherein the AI/ML model is a large language model (LLM).

14. One or more non-transitory computer-readable media storing instructions that are operable, when executed by one or more computers, to cause the one or more computers to perform operations comprising:
storing, by the one or more computers, vector embeddings for each of multiple chatbots;
receiving, by the one or more computers, a text input from a user that is entered at a user device of the user;
selecting, by the one or more computers, a chatbot from among multiple chatbots that the user is authorized to access based on the text input from the user, wherein the chatbot is selected based on a measure of similarity of a vector embedding for the text input from the user to a vector embedding for the selected chatbot;
based on the selection, generating, by the one or more computers, a chatbot response to the text input from the user using the selected chatbot; and
providing, by the one or more computers, the chatbot response for presentation at the user device.

15. The one or more non-transitory computer-readable media of claim 14, wherein the vector embedding for each chatbot of the multiple chatbots is based on properties of one or more data sets that the chatbot is configured to access.

16. The one or more non-transitory computer-readable media of claim 14, wherein the vector embedding for each chatbot of the multiple chatbots is based on a description or label for the chatbot.

17. The one or more non-transitory computer-readable media of claim 14, wherein the vector embedding for each chatbot of the multiple chatbots is based on previous user interactions with the chatbot.

18. The one or more non-transitory computer-readable media of claim 14, wherein selecting the chatbot comprises:
identifying a set of multiple candidate chatbots to answer the text input from the user, wherein the multiple candidate chatbots are identified based on the similarity of their corresponding vector embeddings to the vector embedding for the text input from the user;
providing information describing the multiple candidate chatbots to an artificial intelligence and/or machine learning (AI/ML) model with an instruction for the AI/ML model to select a chatbot that is appropriate to generate a response to the text input from the user or to rank or re-rank the multiple candidate chatbots; and
selecting a chatbot indicated by a response of the AI/ML model.

19. The one or more non-transitory computer-readable media of claim 18, wherein the AI/ML model is a large language model (LLM).

20. The one or more non-transitory computer-readable media of claim 14, comprising:
detecting that a chatbot has been added or altered; and
in response to detecting that the chatbot has been added or altered, generating one or more new vector embeddings to register the added or altered chatbot.
